(19) United States
(12) Patent Application Publication
(10) Pub. No.: US 2012/0008810 A1
(43) Pub. Date: Jan. 12, 2012

(54) SPEAKER BOX

(76) Inventors: Ji-Liang Lu, Shenzhen (CN); Wen-Tao Jiang, Shenzhen (CN)

(21) Appl. No.: 13/016,077

(22) Filed: Jan. 28, 2011

(30) Foreign Application Priority Data
Jul. 9, 2010 (CN) 201010224383.2

(51) Int. Cl. H04R 1/02; A47B 81/06

(52) U.S. Cl. 381/332; 181/199

(57) ABSTRACT

A speaker box includes a frame defining an upper side and a lower side opposite to the upper side, an electroacoustic transducer received in the frame and including a diaphragm with an edge thereof being fixed to the upper side of the frame, a case defining a plate facing the diaphragm and a sidewall extending upwardly from the plate and positioned on the upper side of the frame, a room formed between the diaphragm and the case, a hole defined at the side of the case for outputting the sound wave produced by the diaphragm. The plate defines a plurality of slots extending from the joint of the plate and the sidewall to towards the hole to connect to the hole, the slots being spaced each other and configured for leading the air of the room to get out through the hole.

### FIELD OF THE INVENTION

The present invention generally relates to speaker boxes, and more particularly, to a speaker box having a side hole for outputting sound waves.

RELATED ART OF THE INVENTION

Gradually, speaker boxes are widely used in many types of portable electronic devices, such as mobile phones, notebook computers, hearing aids, for converting audio electrical signals to audible sounds.

Generally, a related speaker box includes a frame defining a center cavity, a magnetic circuit system received in the center cavity for forming a magnetic gap therebetween, a coil suspended in the magnetic gap, a diaphragm coupled with the coil with a peripheral edge thereof fixed to the frame, an upper cover fixed to an upper side of the frame and a lower cover fixed to a lower side of the frame. And, the diaphragm faces the upper cover, with a room formed between the diaphragm and the upper cover. An opening is formed on the room and provided for outputting sound waves produced by the diaphragm. Furthermore, the opening is located at a side of the upper cover and/or the upper side of the frame. Then, the opening is formed along a side direction of the diaphragm, not directly face the diaphragm.

Such configuration of the speaker box is mentioned above, when a volume of the room becomes smaller, a range of high frequency of the sound waves can get much wider. So, in order to reduce the volume of the room, a distance of the upper cover and the diaphragm is designed much shorter, or a thickness of the upper cover is designed much bigger. However, when the distance between the upper cover and the diaphragm is too shorter, the acoustic impedance in the room will increase, so, which affects the performance of the speaker box.

Therefore, an improved speaker box that can resolve the problems mentioned-above is desired.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments.

FIG. 1 depicts an isometric exploded view of a speaker box in accordance with one exemplary embodiment of the present invention.

FIG. 2 depicts a partially isometric assembled view of the speaker box of FIG. 1.

FIG. 3 depicts an isometric assembled view of the speaker box of FIG. 1.

FIG. 4 depicts a cross-sectional view of the speaker box taken along line IV-IV in FIG. 3.

FIG. 5 depicts an isometric view of an upper case of the speaker box of FIG. 1.

### DETAILED DESCRIPTION OF THE EXEMPLARY EMBODIMENT

Embodiment of the present disclosure will now be described in detail below, with reference to the accompanying drawings.

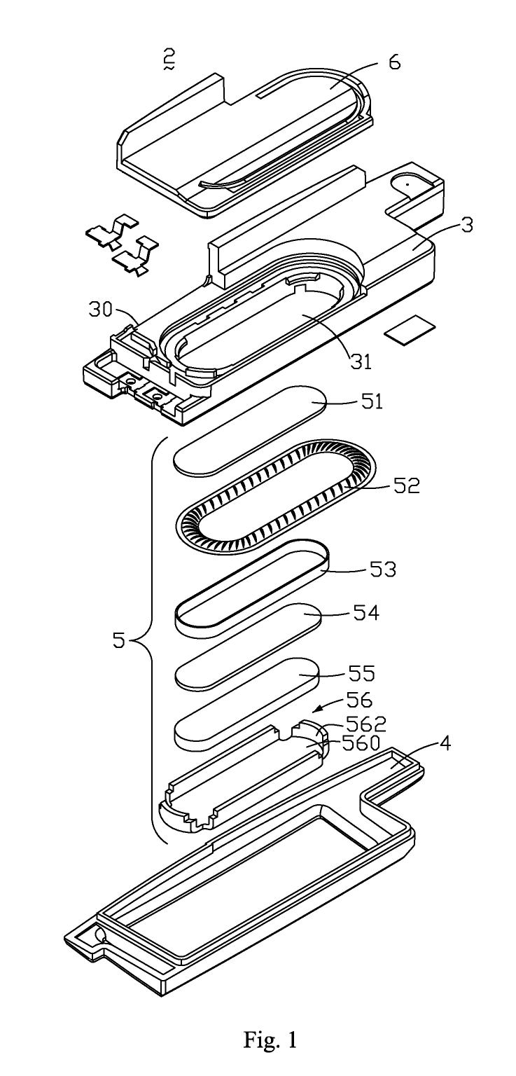

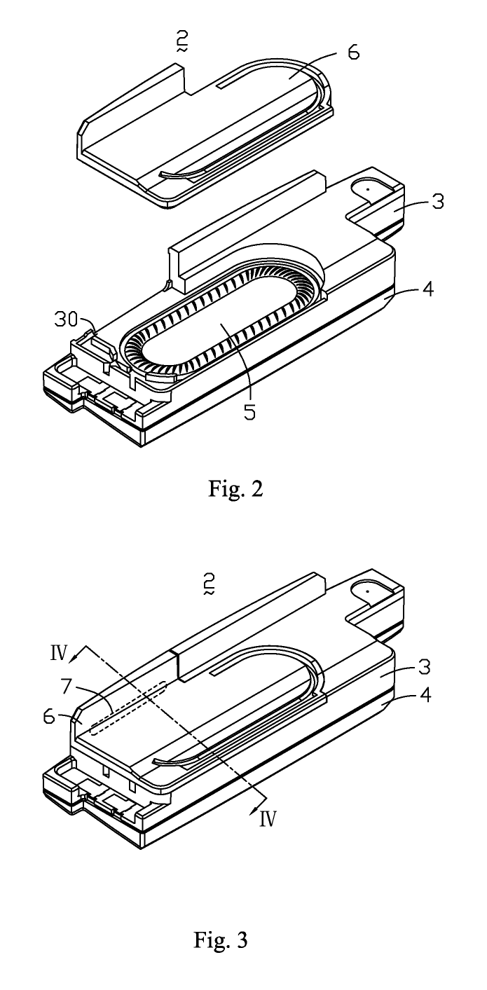

Referring to FIGS. 1-3, a speaker box 2, according to an exemplary embodiment, includes a frame 3 defining a center hole 31, a lower case 4 coupled with a lower side of the frame 3, an upper case 6 coupled with an upper side of the frame 3, and an electroacoustic transducer 5 received in the center hole 31 of the frame 3.

The electroacoustic transducer 5 is used for converting audio electrical signals to audible sounds and includes a yoke 56 received in the center hole 31 of the frame 3, a magnet 55 fixed in the yoke 56, a plate 54 positioned on an upper surface of the magnet 55, a coil 53 suspended in a magnetic gap formed between the yoke 56 and the magnet 55, a diaphragm 52 connected to the coil 53 with a edge thereof fixed to the upper side of the frame 3, and a mass 51 mounted on a center part of the diaphragm 52 for increasing the vibration performance of the diaphragm 52. In the present embodiment, the yoke 56 defines a bottom 560 and a plurality of sidewalls 562 extending upwardly and perpendicularly from the bottom 560.

While assembling the speaker box 2, the electroacoustic transducer 5 is received in the center hole 31 of the frame 3. The lower case 4 is fixed to the lower side of the frame 3 and faces the bottom 560 of the yoke 56. The upper case 6 is positioned on the upper side of the frame 3 and faces the diaphragm 52. Therefore, the frame 3, the upper case 6, and the lower case 4 cooperatively form a receiving space (not labeled) for receiving and supporting the electroacoustic transducer 5 therein.

The upper case 6 includes a plate 61 facing the diaphragm 52 and a sidewall 64 extending upwardly from the periphery of the plate 61. The sidewall 64 is fixed to the upper side of the frame 3. Therefore, a room 100 is formed by the plate 61, the diaphragm 52, the sidewall 64 and the upper side of the frame 3.

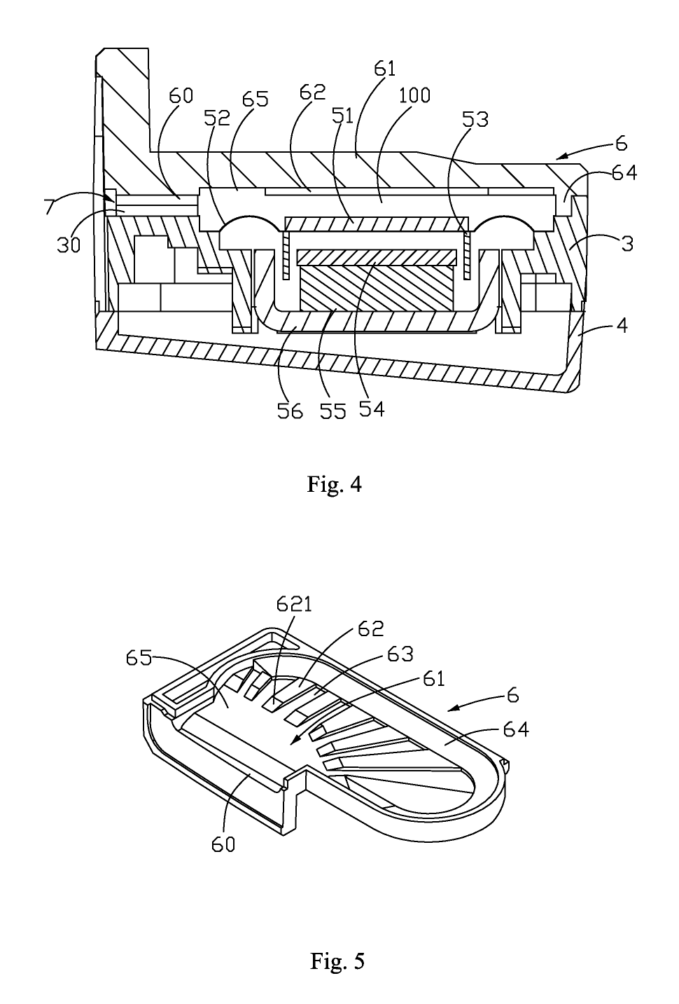

In order to output sound waves produced by the diaphragm 52, the sidewall 64 defines a hole 60, and the upper side of the frame 3 defines a notch 30 (seen in FIG. 4) formed on a side portion thereof to connect with the hole 60, thereby forming a bigger hole 7 by the hole 60 and the notch 30. The bigger hole 7 is designed as an opening of the room 100 so that the air of the room 100 can get out via the bigger hole 7. In the present embodiment, the bigger hole 7 is formed along a side direction of the diaphragm 52. That is to say, the bigger hole 7 does not directly face the diaphragm 52.

It is to be understood, in other embodiments. The bigger hole 7 can only be defined at the sidewall 64 of the upper case 6, or only be defined at the upper side of the frame 3.

The plate 61 defines a plurality of projections 62 extending from the joint of the plate 61 and the sidewall 64 towards the center of the plate 61, and a plurality of gaps 63 formed adjacent to the projections 62. The projections 62 are formed on the bottom of the plate 61 to face the upper side of the diaphragm 52. Each gap 63 is formed between two adjacent projections 62 and connects to the hole 60 of the upper case 6. All of the gaps 63 can lead the air of the room 100 to get out through the hole 60. Furthermore, a receiving cavity 65 is formed between the bottom of the plate 61 and the sidewall 64 to be adjacent to the hole 60, and is coplanar with bottom of the gap 63.

Furthermore, a beveled surface 621 is formed at the distal end of the projection 62 to slantwise face the hole 60.

While manufacturing the upper case 6, the plate 61 of the upper case 6 can be thickened for reducing the distance of the inner surface of the diaphragm 52 and the upper case 6 so as to reduce the volume of the room, and the plurality of the gaps 63 and the receiving cavity 65 are formed on the inner surface of the plate 61 by carving.

When electrified, the coil 53 is forced to move and drive the diaphragm 52 to move upwardly and downwardly for producing sound waves. The gaps 63 lead the air of the room 100 to get out via the bigger hole 7 so as to reduce the acoustic impedance in the room 100, thereby, for increasing the range of the high frequency of the speaker box via reducing the distance of the upper case and the diaphragm. Thus, the performance of the speaker box is improved.

While the present invention has been described with reference to a specific embodiment, the description of the invention is illustrative and is not to be construed as limiting the invention. Various of modifications to the present invention can be made to the exemplary embodiment by those skilled in the art without departing from the true spirit and scope of the invention as defined by the appended claims.

What is claimed is:

1. A speaker box, comprising:
a frame defining an upper side and a lower side opposite to the upper side;
an electroacoustic transducer received in the frame and including a diaphragm with an edge thereof being fixed to the upper side of the frame;
a case defining a plate facing the diaphragm and a sidewall extending upwardly and perpendicularly from the plate to be positioned on the upper side of the frame;
a room formed between the diaphragm and the case;
a hole defined at the sidewall of the case and communicating with the room for outputting the sound wave produced by the diaphragm; wherein,
the plate defines a plurality of projections extending from the joint of the plate and sidewall towards the hole and formed on the bottom of the plate to face the upper portion of the diaphragm, a gap formed between every two adjacent projections and communicating with the hole of the case and configured for leading the air of the room to get out through the hole.

2. The speaker box as described in claim 1, wherein the upper side of the frame defines a notch on a side thereof for engaging with the hole of the case.

3. The speaker box as described in claim 1, wherein a beveled surface is formed at the distal end of the projection to slantwise face the hole.

4. The speaker box as described in claim 1, wherein a receiving cavity is formed adjacent to the hole of the case, and is coplanar with the bottom of the gap.

5. The speaker box as described in claim 1, wherein further comprising a lower case fixed to the lower side of the frame.

6. A speaker box, comprising:
a diaphragm;
a house receiving the diaphragm therein, and defining a plate facing the diaphragm and a sidewall formed between the plate and the diaphragm;
a room formed between the diaphragm, the plate and the sidewall;
a hole defined at the sidewall and connected to the room for outputting the sound wave produced by the diaphragm; wherein,
the plate defines a plurality of slots extending from the joint of the plate and the sidewall towards the hole to connect to the hole, the slots being spaced each other and configured for leading the air of the room to get out through the hole.

7. The speaker box as described in claim 6, therein a projection is formed between every two adjacent slots.

8. The speaker box as described in claim 7, therein a beveled surface is formed at the distal end of the projection to slantwise the hole.

9. The speaker box as described in claim 6, therein the house further comprises a frame defining an upper side and a lower side opposite to the upper side, and a case positioned on the upper side of the frame.

10. The speaker box as described in claim 9, therein further comprising an electroacoustic transducer received in the frame, and the diaphragm is formed on an edge of the transducer to be fixed to the upper side of the frame.

11. The speaker box as described in claim 9, therein the upper side of the frame defines a notch on a side thereof, the notch cooperatively with the hole to form a bigger hole.

12. The speaker box as described in claim 11, therein the transducer includes a yoke received in the frame, a magnet fixed in the yoke, a plate positioned on an upper surface of the magnet, a coil suspended in a magnetic gap formed between the yoke and the magnet, an a mass mounted on a center portion of the diaphragm for increasing the vibration performance of the diaphragm.
